(19) United States
(12) Patent Application Publication
(10) Pub. No.: US 2003/0209037 A1
(43) Pub. Date: Nov. 13, 2003

(54) Forming apparatus and forming method

(75) Inventor: Shigeru Hosoe, Tokyo (JP)

Correspondence Address: Finnegan, Henderson, Farabow,, Garrett & Dunner, L.L.P., 1300 I Street, N. W., Washington, DC, 20005-3315, US

(73) Assignee: KONICA CORPORATION

(21) Appl. No.: 10/430,437

(22) Filed: May 7, 2003

(30) Foreign Application Priority Data
May 10, 2002 (JP) JP2002-135244

(51) Int. Cl. C03B 11/06; C03B 11/12

(52) U.S. Cl. 65/318; 65/356; 65/374.13; 65/374.15

(57) ABSTRACT

An apparatus for forming a product by a pressing process, has

a forming die to have a forming cavity; a shifting member to hold the forming die and siftable forwardly backwardly in a first direction so as to press the product; a stationary member having a hollow section in which the shifting member is inserted to be shiftable; and a supplying device having a supplying section, which is made of a porous material, to supply a pressure transmitting medium into a gap between an outer surface of the shifting member and an inner surface of the hollow section so as to displace the shifting member in a direction intersecting with the first direction.

### BACKGROUND OF THE INVENTION

The present invention relates to a forming apparatus employing a forming die and to a forming method, and in particular, to a forming apparatus and a forming method wherein eccentricity accuracy and axial precision of a processed-product such as, for example, an optical element can be improved without using complicated structures, and highly accurate processed-products can be manufactured stably.

The inventor of the invention has suggested a supporting mechanism employing a non-contact supporting surface which (1) can hold a forming die accurately with excellent reproducibility and (2) can adjust a minute amount of eccentricity highly accurately in a forming apparatus that forms an optical material into an optical element through injection molding or press-forming (TOKKAI No. 2001-341134).

In the supporting mechanism of this kind, non-contact holding can be attained by making a pressure transmission medium to discharge into a clearance between a stationary member and a moving member that supports a forming die, and adjustment of shifted eccentricity in sub μm of the moving member for the stationary member and tilt adjustment in an angle of several tens seconds can be conducted, by giving a difference to the supply pressure for the pressure transmission medium.

However, it was found that a problem is further caused when the supporting mechanism employing the non-contact supporting surface is applied to an optical element forming apparatus. For example, when providing an orifice governor for enhancing supporting stiffness on a discharging outlet for pressure transmission medium, a diameter of the orifice needs to be as extremely small as 0.1-0.2 mm, which causes a problem that the degree of difficulty in manufacturing is extremely high, the cost goes up, and minute dispersion in processing easily affects hydrostatic pressure characteristics.

Although it is possible to enhance supporting stiffness by providing a surface throttle governor (a shallow groove extending along a discharging surface from the orifice governor) on a discharging surface for pressure transmission medium (which is also called a hydrostatic pressure receiving surface), the surface throttle governor requires longitudinal and lateral grooves each having a depth of about 10 μm, and the degree of difficulty for machining is high, which has caused an increase of manufacturing cost. Further, when an orifice governor is provided, a material of the hydrostatic pressure receiving surface needs to be a metal on which a screw can be formed by cutting, because a screw needs to be used for fixing the orifice governor. However, it was found that when forming is accompanied by heating, the heat is transmitted to cause thermal expansion on a non-contact supporting part of the metal, because a linear expansion coefficient of the metal is generally high, and there exists a fear that a clearance between non-contact supporting surfaces becomes narrow and binding is finally caused.

### SUMMARY OF THE INVENTION

The invention has been achieved in view of the problems mentioned above, and its object is to provide a forming apparatus which can support a forming die accurately despite its cost that is low, and to provide a forming method

The forming apparatus described in Structure 1 has therein a moving member (a mobile member) that holds a forming die (at least one forming die when a plurality of forming dies are present) which forms a forming cavity for forming a processed-product through heating press, a stationary member (fixed member) housing therein the moving member, and a supply means that supplies a pressure transmission medium into a clearance between the moving member and the stationary member, and the moving member is supported by the pressure transmission medium supplied from the supply means to the clearance to be movable against the stationary member (in the direction crossing its axial line or the pressing direction, for example), while, the means to supply the pressure transmission medium to the clearance is made of a porous material, thus, the forming die can be supported accurately in spite of the low cost.

### BRIEF DESCRIPTION OF THE DRAWINGS

FIG. 1 is a sectional view of a member showing the principle of the invention.

FIG. 2 is a sectional view of a forming apparatus relating to the first embodiment.

FIG. 3 is a perspective view showing a moving member relating to the variation.

### DETAILED DESCRIPTION OF THE PREFERRED EMBODIMENT

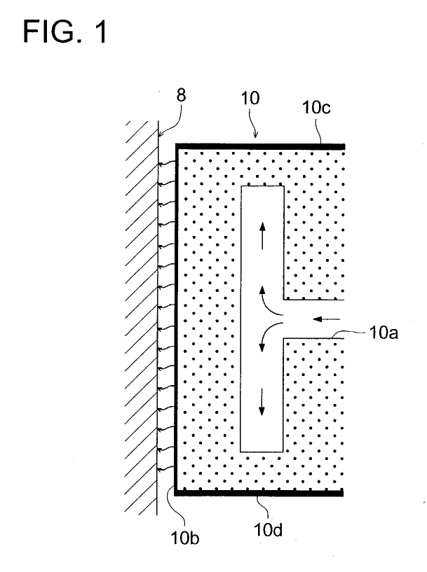

FIG. 1 is a sectional view of the member showing a principle of the invention. In FIG. 1, the vertical direction is a pressing direction, and square-piston-shaped moving member 10 is arranged in square-cylinder-shaped stationary member 8. The moving member 10 is made of a porous material, and inside the moving member, supply path (constituting a part of the supply means) 10a for the pressure transmission medium is formed to extend to the vicinity of the circumferential surface 10b. The pressure transmission medium supplied to the moving member 10 from an outer supply means passes through the supply path 10a to arrive at the vicinity of the circumferential surface 10b, and then, passes through microscopic holes to be discharged toward the stationary member from the surface of the circumferential surface 10b. Incidentally, top surface 10c and underside 10d each representing a non-dischargeable surface on the moving member 10 are subjected to processing to close holes, and the pressure transmission medium does not run out of the top surface 10c and the underside 10d.

In the case of materials generated through sintering such as, for example, graphite or ceramic material, it is possible to obtain a porous material which contains therein microscopic holes evenly, by mixing a material which reduces its volume or is gassified in the course of sintering. By controlling a size and a shape of the microscopic hole, it is possible to make many holes not to be independent holes (blind holes) but to be continuous holes (holes extending continuously from the supply path 10a to the circumferential surface 10b). By forming moving member 10 by the use of the porous material mentioned above and by supplying high-tension pressure transmission medium to the supply path 10a, it is possible to discharge, from the circumferential surface 10b, the pressure transmission media which have passed through many holes.

When the moving member 10 is supported to be movable against stationary member 8 by the use of the pressure transmission medium discharged from the circumferential surface 10b, each microscopic hole of the porous material serves as an orifice governor to enhance the supporting stiffness, and pressure transmission media having uniform pressure on the entire discharging surface are further discharged. Therefore, highly accurate grooves such as surface governors representing a path through which the pressure transmission media are conveyed to the peripheral portions at high pressure which were required in the conventional technology are not necessary, which makes it possible to provide lower cost structures while making accurate supporting to be possible. Incidentally, the moving member 10 of this kind can be formed by a simple method wherein a sheet-shaped porous material is stuck on the surface of a base material on which an inlet to supply pressure transmission medium and a simple groove connected to the inlet are formed, and thereby, manufacturing cost can be reduced sharply. However, the forming method is not limited to this.

For example, when an orifice governor is used, supporting stiffness can be enhanced by reducing an orifice diameter, but when an orifice diameter is made small, a flow rate of pressure transmission medium is reduced and supporting stiffness for the inclination is sharply lowered, which causes a problem that pressure transmission medium at higher pressure must be supplied. In the invention, however, pressure loss for the pressure transmission medium by microscopic holes of the porous material is selected preferably to about ½-⅓, and the problem for the aforementioned inclination can be solved, because supply of pressure transmission medium to the discharging surface (non-contact supporting surface) is carried out for the entire surface. Namely, by using a porous material for the discharging surface of the pressure transmission medium, it is possible to keep shifting stiffness (function to keep a clearance in the direction of crossing an axial line of moving member 10 for stationary member 8 in the example in FIG. 1) and tilt stiffness (function to restore the inclination for the axial line of the moving member 10 for the stationary member 8 in the example in FIG. 1) to be higher while making both of them to be compatible each other, which is a characteristic, and it is possible to control dispersion of eccentricity of a die for forming an optical surface to be small, when forming, for example, an optical element.

Incidentally, when a porous material is used on the discharging surface for pressure transmission medium, microscopic holes (pores) on the surface other than the discharging surface are also made to be continuous from a supply path for pressure transmission medium with blow holes, thereby, there is a fear that pressure transmission medium leaks to the non-discharging surface. In this case, pressure between the discharging surface and the surface facing the discharging surface is declined, and supporting stiffness is lowered. Therefore, it is conceivable that epoxy type resin such as epoxy adhesive agent or epoxy coating, for example, is filled and solidified in a hole on the non-discharging surface through which the pressure transmission medium should not leak to close the hole.

Incidentally, in the method to form a discharging surface for pressure medium by sticking the sheet-shaped porous material on the base material surface that forms a groove, processing cost and the degree of difficulty are both lowered, but there is a problem that the mechanical strength of the porous material is lower because of its blow holes, compared with dense material. Thereupon, it is possible to increase the mechanical strength totally, by integrating the porous material with a material having greater bending strength such as metal material or ceramic material, by the use of adhesive agent solidly, on a backing basis. However, when using metal material as a base material, the coefficient of linear expansion tends to be greater, which calls attention.

As a method to discharge pressure transmission medium from the discharging surface, there are considered an embodiment to discharge toward a moving member from a stationary member and an embodiment (see FIG. 1) to discharge toward a stationary member from a moving member, in the structure composed of a piston-like moving member and a cylinder-like stationary member. In the case of the latter, it is possible to reduce the number of parts and to lower sharply the degree of difficulty by making the piston-like moving member to be of the porous material totally. For example, a blind hole may be made to be away from the discharging surface on the porous material by a few mm toward the inside to be in parallel with an axial line, so that pressure transmission medium may be supplied from the blind hole. Further, when blow holes other than the discharging surface are closed by applying epoxy coating as stated above, a supplied pressure transmission medium is discharged only from the discharging surface, the non-contact clearance neighboring with the stationary member can be kept to be at high pressure by a pressure transmission medium. In this case, since the force received by the discharging surface is only compressive force, no damage is caused on the porous material which is weak in bending strength and is fragile. Further, even in the case of a porous material, for example, of a ceramic material, it is easy to make a hole for a supply path (blind hole is also workable) if an ultrasonic processing is employed, and when the material is conductive, the foregoing is realized simply even by electro-discharge machining, thus, processing is extremely easy, and sharp reduction of cost compared with that in the past is realized.

On the other hand, in the case of an embodiment to discharge a pressure transmission medium toward a moving member from a stationary member, it is necessary to mount a backing member such as a metal on a porous material for securing mechanical strength which should originally be owned by the stationary member. Structures other than this are the same as those in the embodiment stated above.

Though there are considered ceramic materials such as alumina, silicon carbide and silicon nitrate, as a porous material for the invention, any kinds of materials are workable in the invention provided that the material is one wherein many holes can be formed. In addition, the non-contact clearance is usually selected to be about 1 μm-50 μm, and its amount is free in the invention. Further, the pressure transmission medium may be either a liquid such as oil or water, or a gaseous body such as air or nitrogen gas. However, a gaseous body containing 80 mol % or more of air or nitrogen gas is more preferable because it is inexpensive.

In the forming apparatus described in Structure 2, when the processed-product mentioned above is an optical element, the highly accurate optical element can be formed. Incidentally, as an optical element, there are given, for example, a lens, a prism, a diffraction grating optical element (a diffraction lens, a diffraction prism and a diffraction plate), an optical filter (a spatial low-pass filter, a wavelength band-pass filter, a wavelength low-pass filter, a wavelength high-pass filter), a polarization filter (a light detecting element, a light rotating element, a polarization/separation prism), and a phase filter (a phase plate and hologram), to which, however, the invention is not limited.

In the forming apparatus described in Structure 3, it is preferable that the moving member is arranged to be movable in the pressing direction for the stationary member, and the pressure transmission medium is discharged in the direction that crosses the pressing direction.

In the forming apparatus described in Structure 4, it is preferable that the moving member is made of a porous material.

In the forming apparatus described in Structure 5, it is preferable that the porous material that forms the moving member has a discharging surface that discharges the pressure transmission medium and a non-discharging surface other than the discharging surface, and the non-discharging surface has been subjected to processing to close holes.

In the forming apparatus described in Structure 6, it is preferable that the processing to close holes is a processing to soak or coat liquefied substances on the non-discharging surface and to solidify them.

In the forming apparatus described in Structure 7, it is preferable that the liquefied substances are epoxy resins, because the epoxy resin has an appropriate viscosity to soak into a porous material easily, and has high strength after being solidified.

In the forming apparatus described in Structure 8, it is preferable that the stationary member is composed of a porous material and a backing member.

In the forming apparatus described in Structure 9, it is preferable that the porous material that forms a part of the stationary member has a discharging surface that discharges the pressure transmission medium and a non-discharging surface other than the discharging surface, and the non-discharging surface has been subjected to processing to close holes.

In the forming apparatus described in Structure 10, it is preferable that the processing to close holes is a processing to soak or coat liquefied substances on the non-discharging surface and to solidify them.

In the forming apparatus described in Structure 11, it is preferable that the liquefied substances are epoxy resins.

In the forming apparatus described in Structure 12, it is preferable that the porous material is a ceramic material. Since a linear expansion coefficient of ceramic is considerably low in comparison with a metal, even when heat generated in the course of heating press is transmitted, its thermal expansion can be controlled, and troubles such as binding can be restrained.

In the forming apparatus described in Structure 13, it is preferable that the porous material is graphite. The reason for the foregoing is as follows; it has characteristics that a linear expansion coefficient thereof is low in the same way as in the ceramic material and it is excellent in heat conductivity.

In the forming apparatus described in Structure 14, it is preferable that the pressure transmission medium is a gaseous body in which air content or nitrogen content is 80 mol % or more.

In the forming apparatus described in Structure 15, it is preferable that the moving member has a path to let a cooling medium to pass through, because the cooling medium cools the moving member to control its thermal expansion.

In the forming apparatus described in Structure 16, it is preferable that the path is formed by a copper tube.

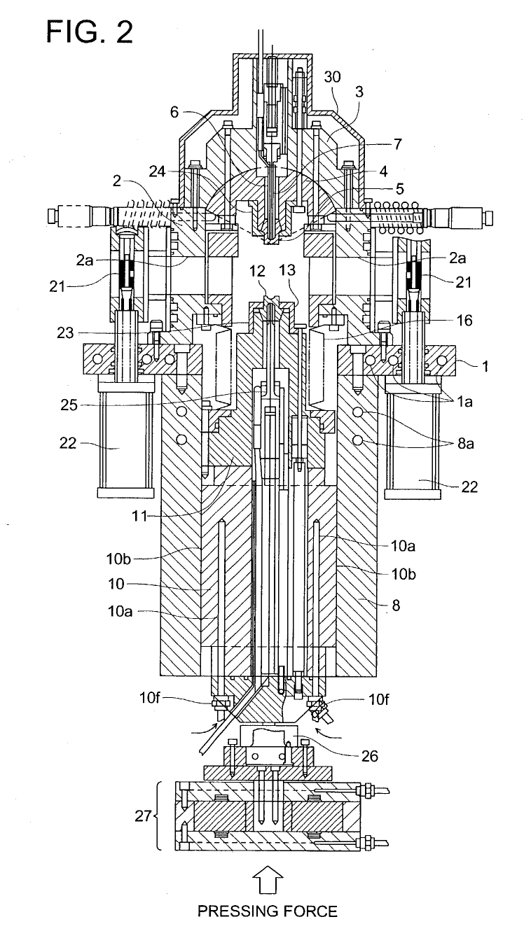

An embodiment of the invention will be explained as follows, referring to the drawings. FIG. 2 is a sectional view of a forming apparatus relating to the present embodiment. The forming apparatus of this kind is one applied to hot press forming mechanism. In FIG. 2, upper die fixing and supporting member 3 is arranged to be fixed at the upper portion of base plate 1 through housing 2. A bottom surface of the upper die fixing and supporting member 3 is spherical in FIG. 2, and in this spherical bottom surface, there is arranged mushroom-shaped swiveling member 4 whose facing surface is spherical so that it may swivel. On the bottom end surface of the swiveling member 4,

upper die 5 constituting a forming cavity is mounted to be fit in a taper surface and is fixed by upper die holder 24. Heater 6 and thermocouple 7 are inserted in the inside of the upper die 5 from the upper portion. An upper portion of the upper die fixing and supporting member 3 is covered by cover 30.

Housing 2 has a pair of openings 2a each being opened in a horizontal direction, and shutter 21 is provided on the end portion of each opening 2a. Each shutter 21 is linked with air cylinder 22 mounted on the housing 2, and it can be moved by the drive of the air cylinder between an open position where the opening 2a is opened and a close position where the opening 2a is engaged.

Lower die fitting and supporting member 8 which is in a shape of a square cylinder is mounted under the base plate 1. Incidentally, inside the base plate 1, there is provided cooling piping 1a through which the cooling water passes, and inside the upper portion of the lower die fitting and supporting member 8 representing a stationary member, there is also provided cooling piping 8a through which the cooling water passes.

Inside the lower die fitting and supporting member 8, there is arranged slider 10. Piston-like-slider 10 is in a shape of a square pole, and it is fit in the inner side of the lower die fitting and supporting member 8, and a clearance between them is about 10 μm. On the upper end of the slider 10, there is attached lower die fixing supporter 11, and lower die (forming die) 12 constituting a forming cavity is mounted on the upper portion of the lower die fixing supporter 11 to be fit in a taper surface, through lower die holder 13. Heater 23 and thermocouple 25 are inserted from the lower portion into the inside of the lower die 12, and the lower die fixing supporter 11 is connected with the slider 10 to be solid each other to move vertically. In the present embodiment, the slider 10 and the lower die fixing supporter 11 constitute a moving member.

Between housing 2 and the lower die fixing supporter 11, there is arranged, on a retractable basis, metal bellows 16 that keeps a processing atmosphere and isolates the slider 10 and the lower die fitting and supporting member 8 from the processing atmosphere on a thermal basis, independently of a movement of the slider 10.

The slider 10 is formed with porous material such as ceramic or graphite, and a plurality of blind holes 10a are formed along the total circumference from the bottom to the vicinity on the upper portion at the position close to circumferential surface 10b (discharging surface). These blind holes 10a are connected to supply inlet 10f connected with a supply source of an unillustrated compression air. Incidentally, on the inner circumferential surface (representing a non-discharging surface) facing a top surface, a bottom surface and the inside of the slider 10, epoxy resins are impregnated and solidified. The bottom portion of the cylinder 10 is linked with an unillustrated driving source through load sensor 26 for detecting pressing force and hydrostatic pressure coupling 27 for adjusting displacement of an axial line.

Incidentally, in the present embodiment, air at the normal temperature (air pressure of 5 atm) representing a pressure transmission medium is supplied to cylinder 10 from an outer air supply source, then, passes through many holes from blind hole 10a representing an air supply path, and is discharged from circumferential (side) surface 10b in the direction that is mostly perpendicular to the pressing direction, and thereby, the slider 10 is supported, on a non-contact basis, against the lower die fitting and supporting member 8. In the case of forming, optical material such as melted glass conveyed from the outside to a space between the upper die and the lower die through opening 2a and shutter 21 is conveyed, by releasing the shutter 21 through controlling to drive air cylinder 2. Further, after the shutter 21 is closed, pressing force is given by an unillustrated drive source from the lower part, so that the slider 10 and the lower die fixing supporter 11 are moved upward by prescribed pressing force based on detection by load sensor 26 to bring the upper die 5 and the lower die 12 close to each other, thus, an optical material is pressed and an optical element having the shape according to the die can be obtained. Then, the air cylinder 2 is controlled to be driven to release the shutter 21, thus, the formed optical element can be conveyed to the outside through the opening 2a. Incidentally, though the lower die fitting and supporting member 8, the slider 10 and their fitting surfaces are made to be square-pole-shaped for the purpose of self-control of rotation on the axis, they may also be cylindrical.

Since the moving member 10 has the structure that is the same as that shown in FIG. 1 in the present embodiment, each microscopic hole in a porous material that communicates the circumferential surface of the moving member representing discharging surface 10b with air supply path 10a serves as an orifice governor, thereby, the supporting stiffness cab be enhanced, and pressure transmission media under the uniform pressure are discharged from the entire discharging surface. Therefore, highly accurate grooves needed for the conventional technology such as a surface governor which serves as a path for conveying air to the peripheral portion under the high pressure is not necessary, and the low cost structure which makes accurate supporting possible can be provided.

### EXAMPLE

A moving member (corresponding to slider 10) in a shape of a 120 mm-square piston was prepared by the use of porous graphite having porosity (rate of holes per unit surface area) of 19%, and blow holes other than those on a discharging surface representing a circumferential surface were impregnated with epoxy coating to be solidified. Seven deep holes each having a diameter of 5 mm were made to be in parallel with the axial line at 15 mm intervals at a depth of 5 mm from the surface on a discharge surface of the moving member so that air at 5 barometric pressure representing a pressure transmission medium may be supplied. In this case, pressure loss at the moment when air leaking from the discharging surface is directly released in the atmosphere was about ½. The piston-like moving member was surrounded by 40 mm-thick stainless steel material in a shape of a cylinder, and was fixed so that the direction of piston movement may be perpendicular to a main body of a forming apparatus shown in FIG. 2. A non-contact clearance between the piston-like moving member and the cylinder-like stationary member (corresponding to stationary member 8) was made to be 10 μm with which a range of adjustment for die shifting seems to be appropriate.

Each of a confronting surface of the piston-like moving member and that of the cylinder-like stationary member is a plane having a flatness of 2 μm or less which was created simply by only a surface grinding work.

In this case, supporting stiffness relating to shifting of the moving member was 650 N/μm which is higher by 30% than that in the conventional technology wherein a orifice governor and a surface governor are used. Further, sensitivity of adjustment for die shifting (sensitivity for adjusting eccentricity by giving differential pressure) in the case of giving differential pressure to the clearances facing each other with an axial line between was 0.25 μm/atm which was a sufficient value as sensitivity for eccentricity adjustment for forming die of a highly accurate optical element. Weight of the piston-like moving member was 6600 g which was ⅕ of weight of the moving member made of stainless steel. Therefore, the driving mechanism for the piston-like moving member was downsized to ½, and required driving force was reduced to about ¼ or less. In addition, a linear expansion coefficient of graphite is about ¼ of stainless steel, and thermal conductivity is 10 times larger, therefore, when a die and an optical material are heated in the course of forming, the piston-like moving member 10 tends to be at uniform temperature totally, and therefore, deformation causing one-sided thermal expansion was hardly caused, and an amount of thermal expansion was small, resulting in no disappearance of non-contact clearance.

As stated above, it was found out that it is possible to realize a non-contact supporting structure wherein manufacturing cost is low, the structure is simple, weight is light, reliability is high and a driving system can be downsized, by using porous graphite, in comparison with an occasion where stainless steel is used and both orifice governor and surface governor are used.

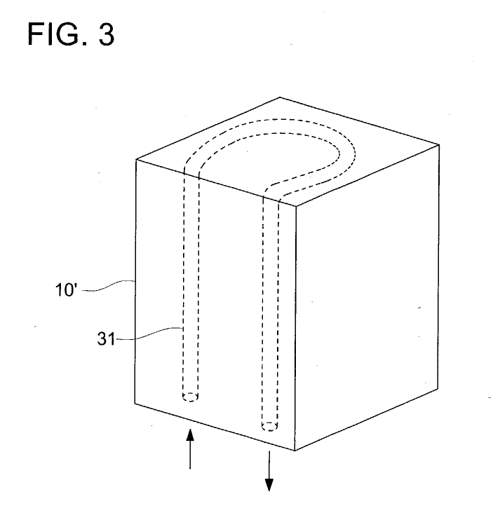

FIG. 3 is a perspective view showing a moving member relating to the variation. In FIG. 3, in moving member 10′, single copper tube 31 extends upward from the bottom surface of the moving member up to the upper portion thereof where the copper tube forms a loop, and then, extends downward from the upper portion. Incidentally, an air supply inlet is omitted. As shown with the arrow mark, by making cooled water representing cooling medium to flow through a path in the copper tube 31, temperature rise of the moving member 10′ is controlled, and thermal expansion is restrained, thereby, binding of the moving member can be repressed effectively, when it is heated in the course of press forming.

The invention has been explained above, referring to the embodiments to which, the invention is not limited in its interpretation, and modification and improvement can naturally be made.

The invention makes it possible to provide a forming apparatus and a forming method wherein a forming die can be supported accurately, in spite of low cost.

What is claimed is:

1. An apparatus for forming a product by a pressing process, comprising:
a forming die to have a forming cavity;
a shifting member to hold the forming die and siftable forwardly backwardly in a first direction so as to press the product;
a stationary member having a hollow section in which the shifting member is inserted to be shiftable; and
a supplying device having a supplying section, which is made of a porous maerial, to supply a pressure transmitting medium into a gap between an outer surface of the shifting member and an inner surface of the hollow section so as to displace the shifting member in a direction intersecting with the first direction.

2. The apparatus of claim 1, wherein the forming die is a forming die to form an optical element.

3. The apparatus of claim 1, wherein the supplying section is structured to discharge the pressure transmitting medium in the direction intersecting with the first direction.

4. The apparatus of claim 1, wherein the shifting member is provided with the supplying section made of the porous material.

5. The apparatus of claim 4, wherein the porous material has a discharging surface to discharge the pressure transmitting medium and a non-discharging surface other than the discharging surface, and wherein pores of the non-discharging surface are closed.

6. The apparatus of claim 5, wherein the non-discharging surface is coated or absorbed a liquid material and the pores of the non-discharging surface are closed by the solidified liquid material.

7. The apparatus of claim 6, wherein the liquid material is epoxy resin.

8. The apparatus of claim 1, wherein the stationary member is provided with the supplying section made of the porous material.

9. The apparatus of claim 8, wherein the stationary member comprises a lining member to cover a back surface of the porous material.

10. The apparatus of claim 8, wherein the porous material has a discharging surface to discharge the pressure transmitting medium and a non-discharging surface other than the discharging surface, and wherein pores of the non-discharging surface are closed.

11. The apparatus of claim 10, wherein the non-discharging surface is coated with or absorbed a liquid material and the pores of the non-discharging surface are closed by the solidified liquid material.

12. The apparatus of claim 11, wherein the liquid material is epoxy resin.

13. The apparatus of claim 1, wherein the porous material is a ceramic material.

14. The apparatus of claim 1, wherein the porous material is graphite.

15. The apparatus of claim 1, wherein the pressure transmitting medium is one of air and a gas having a nitrogen content of 80 mol % or more.

16. The apparatus of claim 1, wherein the shifting member has a conduit through which a cooling medium passes.

17. The apparatus of claim 16, wherein the conduit is formed by a copper tube.

18. A method of forming a product with the apparatus of claim 1.
